(19) United States
(12) Patent Application Publication
(10) Pub. No.: US 2018/0202473 A1
(43) Pub. Date: Jul. 19, 2018

(54) Connecting Device of a Manifold Valve

(71) Applicant: Airtac International Group, Grand Cayman (KY)

(72) Inventors: Shih-Chung Wang, New Taipei City (TW); Jui-Yi Lee, Tainan City (TW); Zheng-Wei Liu, Tainan City (TW); Wen-Cheng Hsu, Tainan City (TW)

(21) Appl. No.: 15/493,525

(22) Filed: Apr. 21, 2017

(30) Foreign Application Priority Data
Jan. 17, 2017 (TW) 106101528

(51) Int. Cl. F15B 13/08

(52) U.S. Cl. CPC F15B 13/0857; F15B 13/0875; F15B 13/0814

(57) ABSTRACT

A connecting device configured to electrically connect a solenoid valve to a manifold base includes a housing and two spaced-apart conductive bodies disposed inside the housing. The housing has a valve-connecting portion configured to be connected to the solenoid valve, and a base-connecting portion configured to be connected to the manifold base. Each conductive body has a first conductive portion configured to electrically connect with the solenoid valve, a second conductive portion configured to electrically connect with the manifold base, and an electrical connecting portion connected between the first and second conductive portions.

### CROSS-REFERENCE TO RELATED APPLICATION

This application claims priority of Taiwanese Patent Application No. 106101528, filed on Jan. 17, 2017.

### FIELD

The disclosure relates to a connecting device, more particularly to a connecting device of a manifold valve that electrically connects a solenoid valve to a manifold base of the manifold valve

### BACKGROUND

Referring to FIG. 1, a conventional manifold valve 1 includes a manifold base 11 having a circuit board provided therein, at least one solenoid valve 12 mounted on the manifold base 11, and at least one conductive wire unit 13 electrically connecting the solenoid valve 12 to the manifold base 11. The manifold base 11 has a plurality of base insertion holes 111. The solenoid valve 12 has a valve body 121, and an insertion seat 122 connected to one side of the valve body 121. The insertion seat 122 has a seat body 124 provided with a seat insertion groove 123, an electronic control board 125 disposed in the seat body 124, two conductive insert plates 126 electrically connected to the electronic control board 125 and inserted into the seat insertion groove 123, and an indicator light 127. The seat body 124 is further provided with a window 128 corresponding to the indicator light 127. The conductive wire unit 13 has two plugs 131 respectively inserted into the seat insertion groove 123 and a corresponding one of the base insertion holes 111, and two conductive wires 132 interconnecting the plugs 131.

Although the conventional manifold valve 1 uses the conductive wire unit 13 to electrically connect the solenoid valve 12 to the manifold base 11, since the manifold base 11 is usually mounted with a plurality of solenoid valves 12 and since each solenoid valve 12 needs a conductive wire unit 13 for electrical connection with the manifold base 11, many conductive wires 132 are exposed from the manifold valve 1 after the solenoid valves 12 are assembled on the manifold base 11. The exposed conductive wires 132 are not only messy and difficult to arrange, but also can adversely affect assembly and disassembly of adjacent solenoid valves 12. Furthermore, the conductive wire unit 13 located outside the insertion seat 122 can easily cover the window 128 of the solenoid valve 12. Thus, inspection and maintenance of the conventional manifold valve 1 are inconvenient.

### SUMMARY

Therefore, an object of the present disclosure is to provide a connecting device of a manifold valve that can alleviate at least one of the drawbacks of the prior art.

Accordingly, a connecting device of a manifold valve of this disclosure is configured to electrically connect a solenoid valve to a manifold base, and includes a housing and two spaced-apart conductive bodies disposed inside the housing. The housing has a valve-connecting portion configured to be connected to the solenoid valve, and a base-connecting portion configured to be connected to the manifold base e Each of the conductive bodies has a first conductive portion configured to electrically connect with the solenoid valve, a second conductive portion configured to electrically connect with the manifold base, and an electrical connecting portion connected between the first and second conductive portions.

### BRIEF DESCRIPTION OF THE DRAWINGS

Other features and advantages of the disclosure will become apparent in the following detailed description of the embodiments with reference to the accompanying drawings, of which:

FIG. 1 is a partly exploded perspective view of a conventional manifold valve;

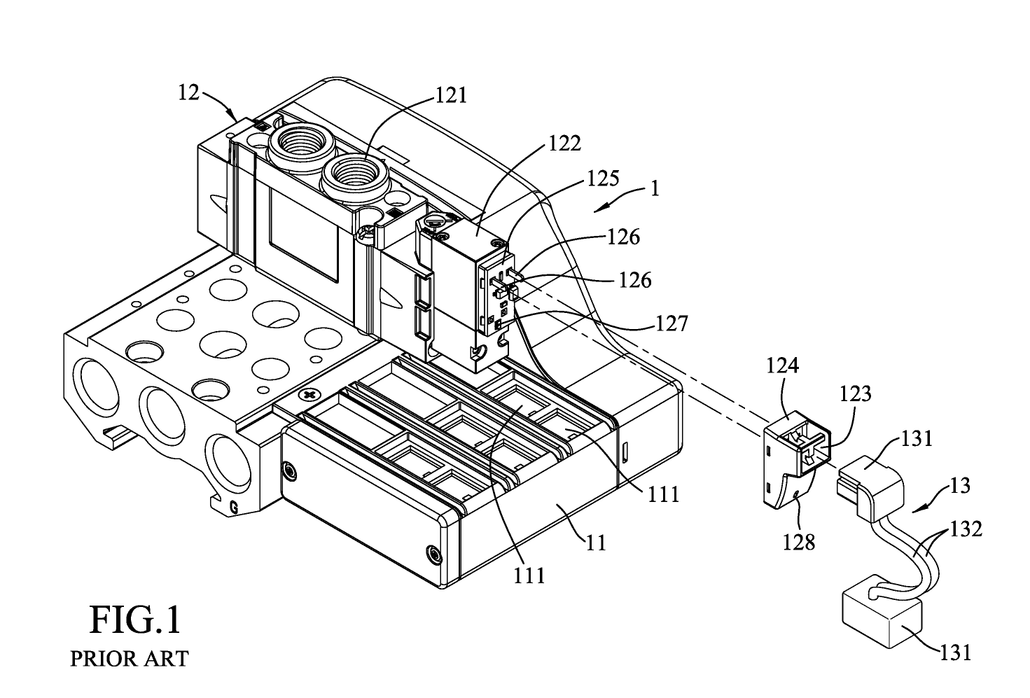

FIG. 2 is a partly exploded perspective view of a manifold valve incorporating a connecting device according to the first embodiment of the present disclosure;

FIG. 3 is an exploded perspective view of the first embodiment and a solenoid valve;

FIG. 4 is an exploded sectional view of the first embodiment, illustrating a relation between the first embodiment and the solenoid valve;

FIG. 5 is a perspective view of a connecting seat of the first, embodiment;

FIG. 6 is a partly sectional side view of FIG. 2, illustrating the relation between the first embodiment and the solenoid valve;

FIG. 7 is an enlarged fragmentary sectional view of FIG. 2 in an assembled state;

FIG. 8 is an enlarged fragmentary exploded sectional view, illustrating a relation between a connecting device according to the second embodiment of the present disclosure and a solenoid valve; and

FIG. 9 is an exploded perspective view of a connecting device according to the third embodiment of the present disclosure, illustrating a relation between the third embodiment and a solenoid valve.

### DETAILED DESCRIPTION

Before the present disclosure is described in greater detail with reference to the accompanying embodiments, it should be noted herein that like elements are denoted by the same reference numerals throughout the disclosure.

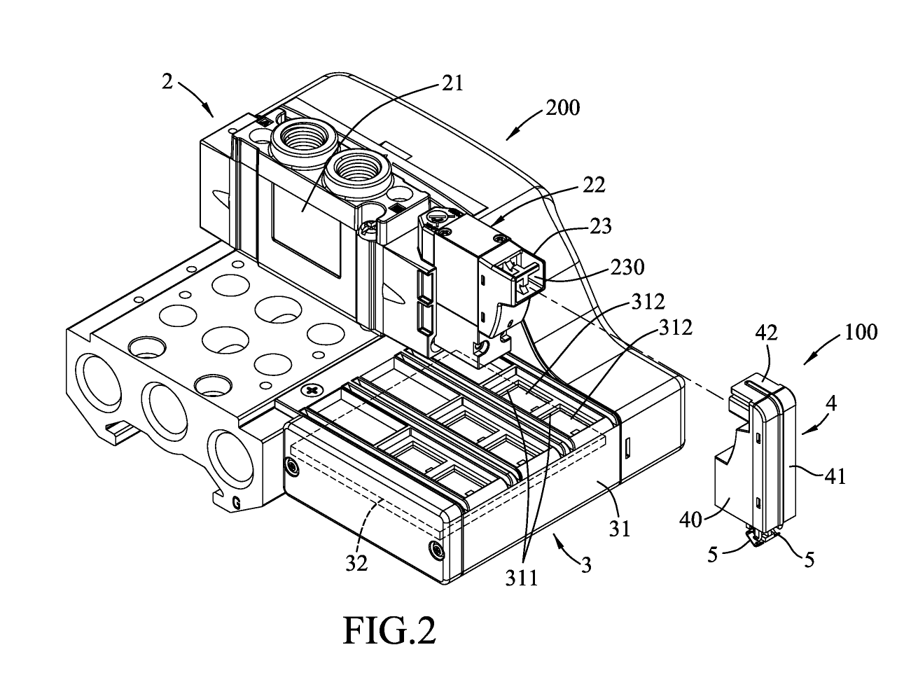

Referring to FIG. 2, a manifold valve 200 includes a manifold base 3, at least one solenoid valve 2 mounted on the manifold base 3, and a connecting device 100 according to the first embodiment of this disclosure. The connecting device 100 is configured to electrically connect the solenoid valve 2 to the manifold base 3.

The solenoid valve 2 has a valve body 21 for entry and exit of a fluid, and an insertion seat 22 connected to one side of the valve body 21 for controlling the entry and exit of the fluid into and out of the valve body 21. The insertion seat 22, as shown in FIG. 2, includes an insertion seat body 23 made of a non-conductive material, an electronic control board 221 disposed in the insertion seat body 23 and provided with control circuits, two conductive insert plates 222 electrically mounted to the electronic control hoard 221, and an indicator light 223 electrically mounted to the electronic control board 221 below the conductive insert plates 222.

The insertion seat body 23 includes two spaced-apart groove sidewalls 231, a groove bottom wall 232 connected to the groove sidewalls 231 and cooperating therewith to define a seat insertion groove 230, and a curved wall 233 extending downwardly, curvedly and inwardly from the groove bottom wall 232. The curved wall 233 has a window 234 corresponding to the indicator light 223. The insertion seat body 23 further includes a cross bar 235 connected between the groove sidewalls 231, and a partition wall 236 connected between the cross bar 235 and the groove bottom wall 231. The seat insertion groove 230 is divided by the partition wall 236 into two half-grooves 239 each of which has a side opening 237 facing the connecting device 100, and a top opening 238 facing upward. The conductive insert plates 222 respectively extend into the half-grooves 239. The manifold base 3 includes a base body 31, and a circuit board 32 disposed inside the base body 31 and having a plurality of connecting points. The base body 31 has a plurality of base insertion holes 312 formed in a top portion thereof and each of which is defined by a hole-defining wall 311.

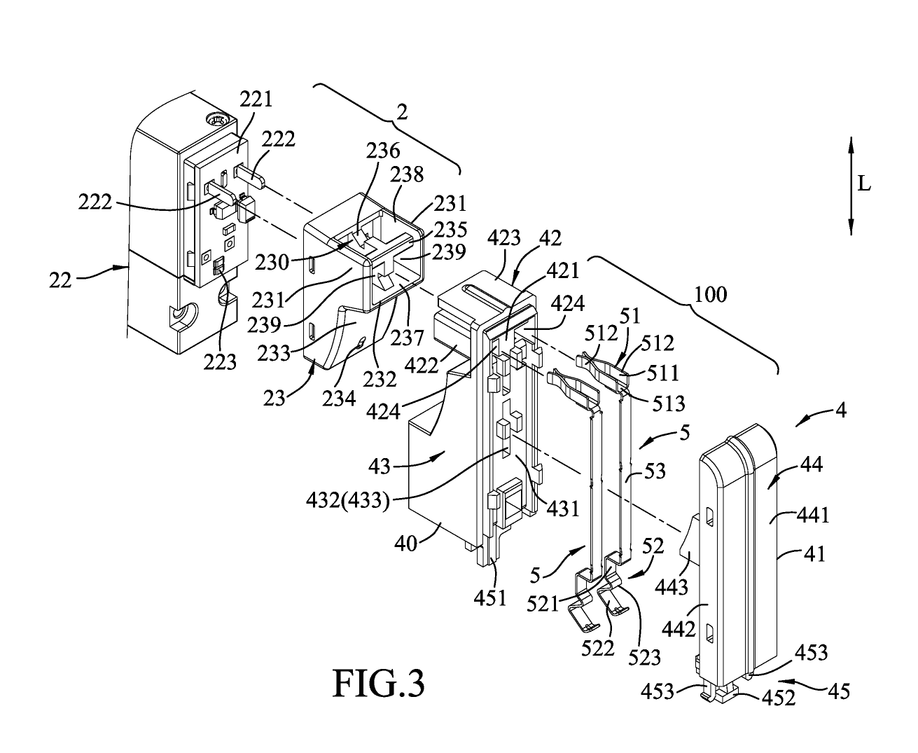

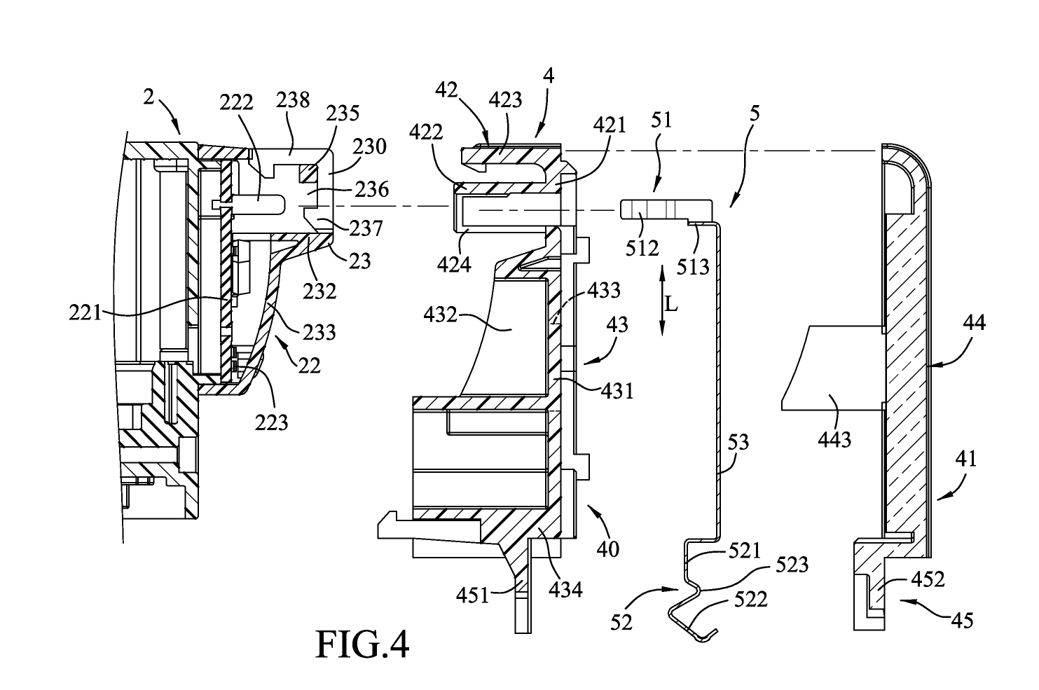

Referring to FIGS. 3 and 4, in combination with FIG. 2, the connecting device 100 of this embodiment includes a housing 4 configured to be disposed between the solenoid valve 2 and the manifold base 3, and two spaced-apart conductive bodies 5 disposed inside the housing 4.

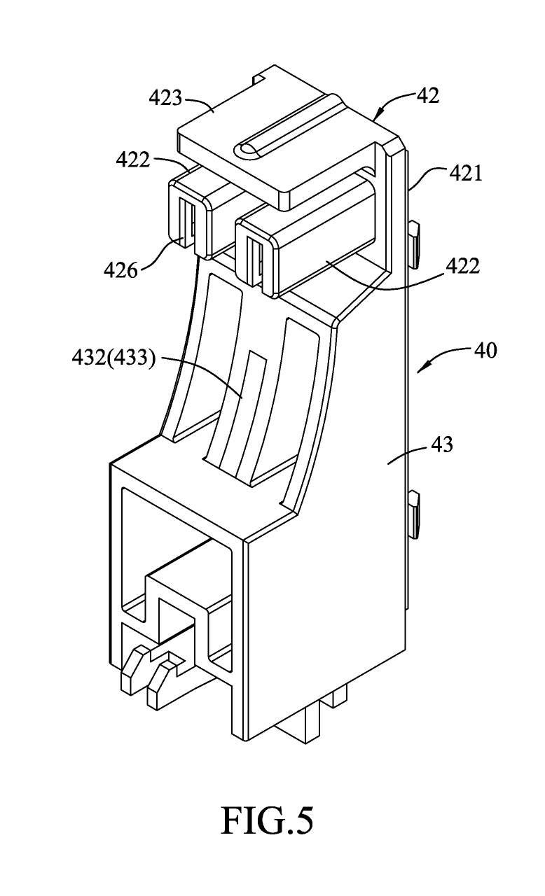

The housing 4 includes a connecting seat 40 made of a non-light transmitting plastic material, and an end cover 41 made of a light transmitting plastic material and covering the connecting seat 40. The connecting seat 40 includes a connecting seat body 43, and a valve-connecting portion 42 connected to an upper end of the connecting seat body 43. The valve-connecting portion 42 includes a first wall 421 extending along a length direction (L) of the housing 4 and having two through holes 424 spaced apart from each other along a direction transverse to the length direction (L), two insert frames 422 extending outwardly and transversely from the first wall 421 and respectively insertable into the half-grooves 239 via the side openings 237 thereof, and an end plate 423 extending outwardly and transversely from the first wall 421 above the insert frames 422 for covering the top openings 238 of the half-grooves 239. As shown in FIG. 5, each insert frame 422 has an inverted U-shaped cross section defining a receiving groove 426 that communicates with a respective one of the through holes 424 in the first wall 421.

The connecting seat body 43 includes a second wall 431 extending along the length direction (L), and a light guide channel 433 that extends transversely through the second wall 431, that is defined by a channel-defining wall 432 and that corresponds to the indicator light 223. The first and second walls 421, 431 are connected integrally to each other as one piece.

The end cover 41 has a light guide portion 44 connected to and covering one side of the connecting seat 40 that faces away from the solenoid valve 2, and a base-connecting portion 45 configured to be insertable into one of the base insertion holes 312. The light guide portion 44 includes a light guide wall 441 extending along the length direction (L) and then curving toward the valve-connecting portion 42, two engaging sidewalls 442 extending transversely from two opposite lateral ends of the light guide wall 441 and respectively engaged to two opposite lateral ends of the one side of the connecting seat 40, a bottom wall 444 connected to bottom ends of the light guide wall 441 and the engaging sidewalls 442, and a light guide plate 443 extending from the light guide wall 441 into the light guide channel 433. There is no specific restriction on the shape of the light guide portion 44. The light guide portion 44 may be made of a light-transmitting material so that the entire light guide wall 441 is light transmittable, or just a small area is light transmitting, while the rest is non-light transmitting.

The base-connecting portion 45 includes a first clamping plate 451 protruding downwardly and outwardly from a bottom wall 434 of the connecting seat body 43, a second clamping plate 452 protruding downwardly and outwardly from the bottom wall 444 of the light guide portion 44 and spaced apart from the first clamping plate 451 in a direction transverse to the length direction (L), and two engaging hooks 453 protruding downwardly and outwardly from the bottom wall 444 of the light guide portion 44 and spaced apart from each other in a direction transverse to the length direction (L). The first and second clamping plates 451, 452 are located between the engaging hooks 453. Each of the first and second clamping plates 451, 452 has a T-shaped cross section.

Each conductive body 5 of this embodiment has a first conductive portion 51 inserted into the receiving groove 426 of a respective one of the insert frames 422 through a corresponding one of the through holes 424, a second conductive portion 52 opposite to the first conductive portion 51, and an electrical connecting portion 53 extending along the length direction (L) and connected between the first and second conductive portions 51, 52. The first conductive portion 51 has two conductive clips 512 cooperatively defining an insertion channel 511, and a connecting plate 513 connected to the conductive clips 512 and the electrical connecting portion 53. The insertion channel 511 of this embodiment extends in a direction transverse to the length direction (L). The second conductive portion 52 includes a fixed section 521 connected to a lower end of the electrical connecting portion 53, a curved section 523 connected to the fixed section 521 opposite to the electrical connecting portion 53, and a resilient abutting section 522 extending downwardly and inclinedly from the curved section 523 opposite to the fixed section 521 and then bent upwardly and outwardly. The resilient abutting section 522 is resiliently abuttable against the circuit board 32. There is no specific restriction on the shape of the electrical connecting portion 53 of this disclosure, and may be in the form of a circuit board or other conductive structure.

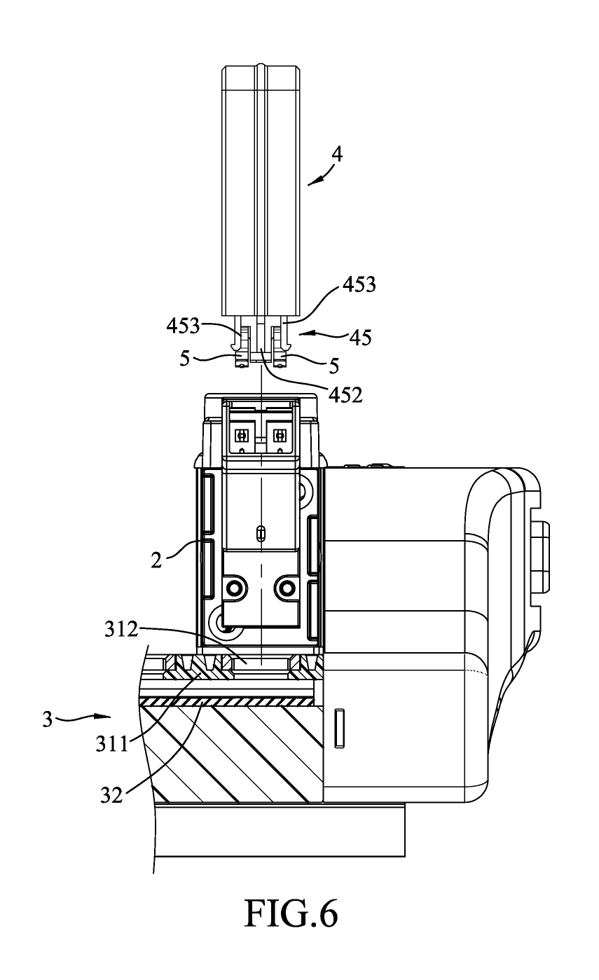

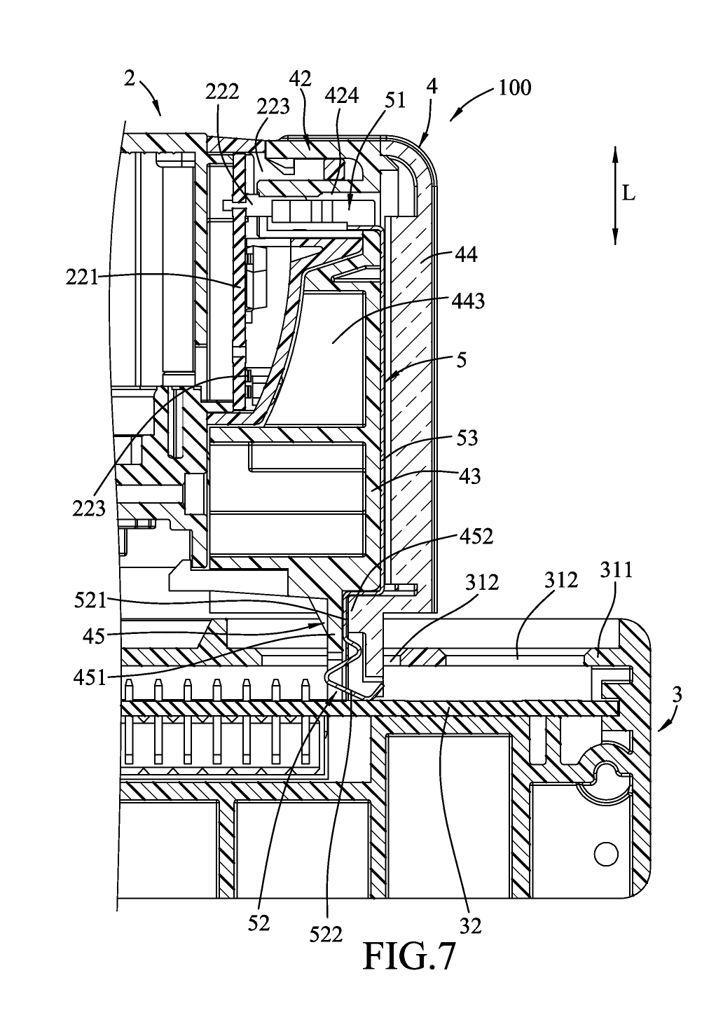

Referring to FIGS. 6 and 7, in combination with FIG. 3, after assembly of the connecting device 100 of this embodiment, the first conductive portion 51 of each conductive body 5 is received in the receiving groove 426 of the respective insert frame 422, the fixed sections 521 of the second conductive portions 52 of the conductive bodies 5 are clamped between the first and second clamping plates 451, 452, and the resilient abutting section 522 of the second conductive portion 52 of each conductive body 5 protrudes out of the housing 4 When the insert frames 422 of the valve-connecting portion 42 of the connecting device 100 are inserted into the respective half-grooves 239 of the insertion seat 22 of the solenoid valve 2, the conductive insert plates 222 will extend into the insertion channels 511 of the respective conductive bodies 5 to achieve electrical connection with the same. Light emitted from the indicator light 223 can be guided by the light guide plate 443 to transmit through the light guide portion 44 for indicating an energized state.

When the base-connecting portion 45 of the connecting device 100 is inserted into a corresponding one of the base insertion holes 312 in the manifold base 3, the engaging hooks 453 thereof are hooked onto a bottom edge of the hole-defining wall 311 of the corresponding base insertion hole 312, and the resilient abutting section 522 of the second conductive portion 52 of each conductive body 5 resiliently abuts against the circuit board 32. Hence, the connecting device 100 can electrically connect the solenoid valve 2 and the manifold base 3.

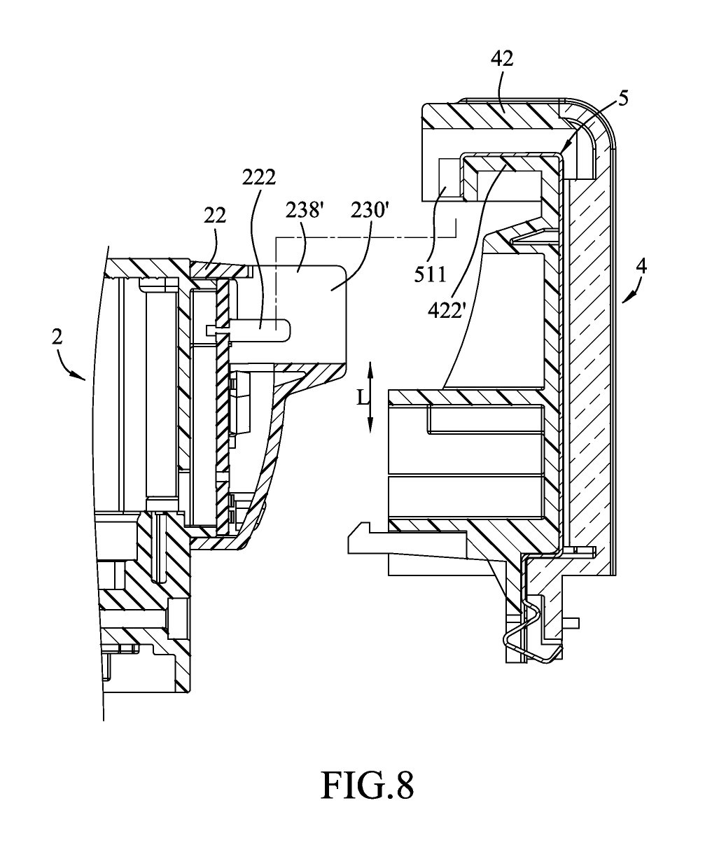

Referring to FIG. 8, the second embodiment of the connecting device 100 of the present disclosure is generally identical to the first embodiment, and differs in that the insertion channel 511 of each conductive body 5 of the second embodiment extends in a direction generally parallel to the length direction (L). A bent plate 422′ of the valve-connecting portion 42 of the housing 4 can be inserted into the seat insertion groove 230′ of the insertion seat 22 through the top opening 238′ thereof, so that the conductive insert plate 222 can extend into the insertion channel 511. By changing the dispositional direction of the insertion channel 511 of each conductive body 5, apart from achieving the expected purpose of this disclosure, the connecting device 100 can also be suitably used in a situation that requires a different insertion direction.

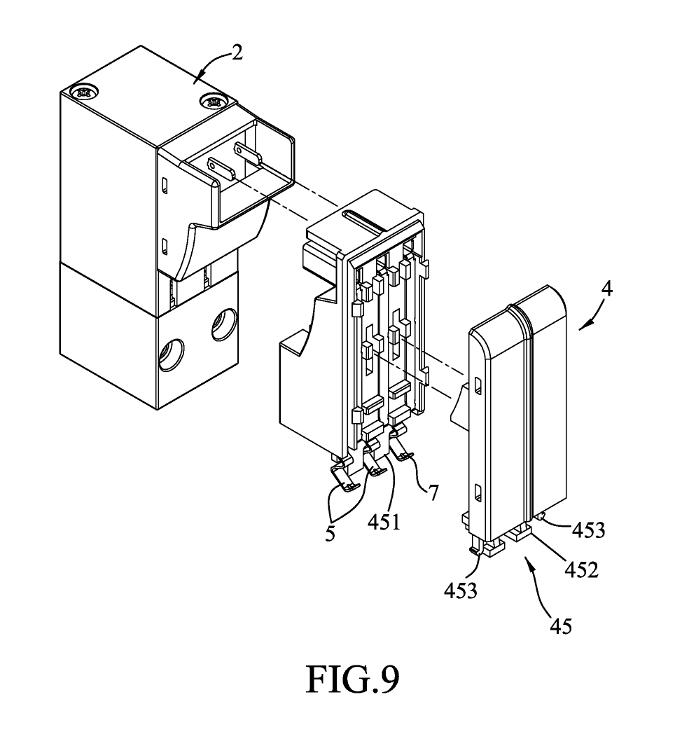

Referring to FIG. 9, the third embodiment of the connecting device 100 of the present disclosure is generally identical to the first embodiment, and differs in that the connecting device 100 of this embodiment further comprises a ground conductor 7 disposed in the housing 4 and configured to electrically connect with the solenoid valve 2 and the manifold base 3. The ground conductor 7 is spaced apart from the conductive bodies 5 in a direction transverse to the length direction (L). The first and second clamping plates 451, 452 of the base-connecting portion 45 of the housing 4 are also used to clamp the conductive bodies 5 and the ground conductor 7, and the engaging hooks 453 thereof are used to engage with the manifold base 3.

It should be noted herein that although insertion methods are exemplified in the embodiments of this disclosure, other method for connecting the housing 4 between the solenoid valve 2 and the manifold base 3 may be employed. Further, the housing 4 may be in the form of a female connector, while the solenoid valve 2 and the manifold base 3 may be in the form of male connectors for cooperating with the female connector. Other forms or shapes of the housing 4, the solenoid valve 2 and the manifold base 3 may be considered, and are not limited to the aforesaid disclosures.

From the aforesaid description, it is apparent that the connecting device 100 of this disclosure uses the conductive bodies 5 disposed inside the housing 4 for electrical connection with the insertion seat 22 of the solenoid valve 2 and the manifold base 3, which is not only novel, but also the entire manifold valve 200 will not have any exposed conductive wires after assembly, so that problems relating to messy conductive wires and interference during assembly will not occur. Moreover, through the presence of the light guide plate 443 in this disclosure, light emitted from the indicator light 223 can be guided by the light guide plate 443 to transmit through the light guide portion 44, so that inspection and maintenance of the connecting device 100 can be facilitated.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A connecting device of a manifold valve configured to electrically connect a solenoid valve to a manifold base, said connecting device comprising:
housing having a valve-connecting portion configured to be connected to the solenoid valve, and a base-connecting portion configured to be connected to the manifold base; and
two spaced-apart conductive bodies disposed inside said housing, each of said conductive bodies having a first conductive portion configured to electrically connect with the solenoid valve, a second conductive portion configured to electrically connect with the manifold base, and an electrical connecting portion connected between said first and second conductive portions.

2. The connecting device as claimed in claim 1, wherein the solenoid valve has a seat insertion groove, and the manifold base has a base insertion hole, and wherein said valve-connecting portion is configured to be inserted into the seat insertion groove, and said base-connecting portion is configured to be inserted into the base insertion hole.

3. The connecting device as claimed in claim 2, wherein said housing includes a connecting seat, and an end cover having a light guide portion connected to and covering said connecting seat, said connecting seat having said valve-connecting portion, and a connecting seat body 43 connected to said valve-connecting portion.

4. The connecting device as claimed in claim 3, wherein said valve-connecting portion includes a first wall extending along a length direction of said housing and having two through holes spaced apart from each other along a direction transverse to the length direction, and two insert frames extending outwardly and transversely from said first wall, each of said insert frames defining a receiving groove that communicates with a respective one of said through holes, said first conductive portion of each of said conductive bodies being inserted into said receiving groove of a respective one of said insert frames through a corresponding one of said through holes, and having two conductive clips cooperatively defining an insertion channel.

5. The connecting device as claimed in claim 4, wherein said insertion channel extends in a direction transverse to the length direction.

6. The connecting device as claimed in claim 4, wherein said insertion channel extends in a direction parallel to the length direction.

7. The connecting device as claimed in claim 4, wherein said second conductive portion of each of said conductive bodies includes a fixed section opposite to said first conductive portion, and a resilient abutting section extending downwardly from said fixed section and configured to electrically connect with the manifold base.

8. The connecting device as claimed in claim 7, wherein said base-connecting portion includes a first clamping plate and a second clamping plate cooperating with each other to clamp therebetween said fixed sections of said second conductive portions of said conductive bodies, and at least one engaging hook configured to engage with the manifold base.

9. The connecting device as claimed in claim 2, wherein said second conductive portion of each of said conductive bodies includes a fixed section opposite to said first conductive portion, and a resilient abutting section extending downwardly from said fixed section and configured to electrically connect with the manifold base.

10. The connecting device as claimed in claim 3, wherein the solenoid valve has an indicator light, and wherein said connecting seat body has a second wall extending along the length direction, and a light guide channel extending transversely through said second wall and corresponding to said indicator light, said light guide portion having a light guide plate extending into said light guide channel.

11. The connecting device as claimed in claim 1, further comprising a ground conductor disposed in said housing and configured to electrically connect with the solenoid valve and the manifold base, said ground conductor being spaced apart from said conductive bodies in a direction transverse to the length direction.
